(19) United States
(12) Patent Application Publication
(10) Pub. No.: US 2026/0229016 A1
(43) Pub. Date: Aug. 6, 2026

(54) METHOD FOR DETECTING OBJECTS OF THE SAME OBJECT TYPE IN AN IMAGE

(71) Applicant: Robert Bosch GmbH, Stuttgart (DE)

(72) Inventors: Christian Graf, Dossenheim (DE); Margret Keuper, Siegen (DE); Markus Spies, Karlsruhe (DE); Yushi Liu, Ditzingen (DE)

(21) Appl. No.: 19/456,069

(22) Filed: Jan. 22, 2026

(30) Foreign Application Priority Data
Jan. 31, 2025 (EP) 25 15 5252.7

(51) Int. Cl. G06V 10/764; B25J 9/16; G06V 10/74

(52) U.S. Cl. CPC G06V 10/764; B25J 9/1697; G06V 10/761

(57) ABSTRACT

A method for detecting objects of the same object type in an image. The method includes: detecting objects in the image; ascertaining a plurality of object pairs; ascertaining a plurality of similarity values by ascertaining, for each object pair, a particular similarity value, which represents a similarity between a first object and a second object of the object pair; the ascertainment of the particular similarity value comprising: ascertaining first feature vectors by ascertaining a first feature vector for multiple pixels of the image that are associated with the first object; ascertaining second feature vectors by ascertaining a second feature vector for multiple pixels of the image that are associated with the second object; ascertaining the particular similarity value using the first feature vectors and the second feature vectors; and, using the plurality of similarity values, grouping the objects into multiple groups.

### BACKGROUND INFORMATION

Picking up (i.e., gripping) an object (e.g., from a container and/or from a table) is an important problem in robotics, also known as a bin picking problem. This requires that a robot be able to detect the objects lying in the container, for example in order to decide which object should be removed. For this purpose, the robot needs to be able to distinguish objects to be removed from other, unwanted objects, such as packaging material.

### SUMMARY

The present disclosure relates to a method that allows efficient detection (e.g., recognition) of objects of the same object type in an image. For example, this allows objects of the same object type to be distinguished from other objects, such as foreign bodies (e.g., packaging material). For example, when objects are removed from a container (i.e., in the case of a bin picking problem), it is possible to distinguish between objects of the same object type and packaging material. This is also possible without classifying the objects, i.e., without ascertaining (e.g., predicting) their object type.

Different aspects relate to a method for detecting objects of the same object type in an image. According to an example embodiment of the present disclosure, the method comprises: detecting a plurality of objects in the image (each object of which is assigned a particular image region in the image); ascertaining a plurality of object pairs, which, for each object of the plurality of objects, has (exactly) one particular object pair with each other object of the plurality of objects; ascertaining a plurality of similarity values by ascertaining, for each object pair of the plurality of object pairs, a particular similarity value representing a similarity between a first object of the object pair and a second object of the object pair according to a (predefined) similarity metric, wherein the ascertainment of the particular similarity value comprises: ascertaining a plurality of first feature vectors by ascertaining a particular first feature vector for multiple pixels of the image (e.g., of the particular image region) that are associated with the first object; ascertaining a plurality of second feature vectors by ascertaining a particular second feature vector for multiple pixels of the image (e.g., of the particular image region) that are associated with the second object; and ascertaining the particular similarity value using the plurality of first feature vectors and the plurality of second feature vectors; and grouping (e.g., clustering) the plurality of objects into multiple groups, at least one group of which contains multiple objects of the same object type, using the plurality of similarity values.

Various exemplary embodiments are specified below.

Example 1 is the method for detecting objects of the same object type in an image as described above.

Example 2 is configured according to Example 1, wherein the detection of the plurality of objects in the image comprises: inputting the image and a text description into a machine learning model, for example a segmentation model (e.g., a segment anything model (SAM) (e.g., grounded SAM)), which is configured, in response to the input of the image and the text description, to output all objects recognized in the image according to the text description as the plurality of objects, wherein a (e.g., predefined) generic term (e.g., “item,” “object,” “product,” “article,” etc.) encompassing object types that are different from one another is input as the text description.

It was found that using a text-prompt-based machine learning model significantly reduces the number of false-positively detected objects (e.g., from background image details) and thus increases the accuracy of the detected multiple objects of the same object type.

Example 3 is configured according to Example 1 or 2, wherein the ascertainment of the plurality of first feature vectors comprises: ascertaining a plurality of first fixed points of the first object, of which each first fixed point is assigned to a particular pixel of the multiple pixels associated with the first object, such that the particular first feature vector is ascertained for each first fixed point; wherein the ascertainment of the plurality of second feature vectors comprises: ascertaining a plurality of second fixed points of the second object, of which each second fixed point is assigned to a particular pixel of the multiple pixels associated with the second object, such that the particular second feature vector is ascertained for each second fixed point; wherein the ascertainment of the particular similarity value using the plurality of first feature vectors and the plurality of second feature vectors comprises: ascertaining one or more fixed point pairs by ascertaining a particular fixed point pair comprising a first fixed point of the plurality of first fixed points and an associated second fixed point of the plurality of second fixed points if a fixed point pair similarity value, which represents a similarity between the particular first feature vector ascertained for the first fixed point and the particular second feature vector ascertained for the second fixed point (according to another similarity metric), is greater than or equal to a fixed point pair similarity threshold; and ascertaining the particular similarity value for the object pair using a number (of fixed point pairs) of the one or more fixed point pairs.

Example 4 is configured according to Example 1 or 2, wherein the ascertainment of the particular similarity value of the plurality of similarity values for an object pair of the plurality of object pairs that has a first object and a second object comprises: ascertaining a plurality of first feature vectors by ascertaining a particular first feature vector for each of one or more pixels of the image that are associated with the first object (e.g., for each pixel or for each group of multiple pixels); ascertaining a first mean feature vector as the mean value of the plurality of first feature vectors; ascertaining a plurality of second feature vectors by ascertaining a particular second feature vector for each pixel of the image associated with the second object; ascertaining a second mean feature vector as the mean value of the plurality of second feature vectors; and ascertaining the particular similarity value for the object pair such that it represents a similarity between the first mean feature vector and the second mean feature vector.

It was found that a significant overlap of the visible regions of the multiple objects is required for the fixed point approach according to Example 3, and that using the mean feature vector according to Example 4 allows an assignment of objects of the same object type even when the overlap of the visible regions is significantly smaller. In some aspects, the plurality of similarity values can also be ascertained from a combination of the fixed point approach according to Example 3 and the mean feature vector approach according to Example 4.

Example 5 is configured according to one of Examples 1 to 4, wherein the grouping of the plurality of objects comprises: clustering the plurality of objects into the multiple groups using a graph-based clustering method (e.g., a minimum-cost multicut approach).

The combination of the use of a text-prompt-based machine learning model (see Example 2) for object recognition with a graph-based clustering method, such as the minimum-cost-multicut approach, allows the detection of objects of the same object type (i.e., repeating objects) without an instance of the objects influencing weights of the machine learning model beforehand (i.e., without an adaptation of the machine learning model). Zero-shot detection of objects of the same object type is thereby clearly provided. This also leads to increased performance in detecting objects of the same object type.

In Example 6, the method according to one of Examples 1 to 5 can optionally further comprise: ascertaining a particular object type for each of the at least one group.

For example, the ascertainment of the particular object type of a group can comprise predicting an associated potential object type for each object of the multiple objects of the group (for example, classifying the object), and then ascertaining the particular object type of the group by majority decision from the predicted potential object types. In this way, the accuracy of the object recognition can be significantly increased by reducing the probability of ascertaining different potential object types for objects of the same object type. Additionally or alternatively, a particular mean feature vector (e.g., as cluster center) can be stored for each class of multiple classes, and the classification can then be carried out using these class-specific mean feature vectors. The accuracy of the classification can clearly be significantly increased.

Example 7 is a method for controlling a robot device, the method comprising: capturing an image showing a plurality of objects in an environment of the robot device (e.g., in a container), of which multiple objects are of the same object type; detecting the multiple objects of the same object type by means of a method according to one of Examples 1 to 6; and controlling the robot device to pick up (e.g., grip) (at least) one object of the multiple objects.

Example 8 is configured according to Example 7, wherein controlling the robot device to pick up the object of the multiple objects comprises: ascertaining, by means of a robot control model, using the information that the multiple objects are of the same object type, a pickup configuration of the robot device to pick up the object and/or a trajectory to move the (picked up) object.

Example 9 is configured according to Example 7 or 8, wherein the multiple objects are multiple first objects of a (same) first object type, and wherein the plurality of objects further comprises multiple second objects of a (same) second object type, which is different from the first object type, such that the multiple groups ascertained by the method comprise a first group comprising the multiple first objects and a second group comprising the multiple second objects; and wherein the method further comprises: controlling the robot device to sort the multiple first objects (e.g., into a first container) and the multiple second objects (e.g., into a second container).

Example 10 is configured according to one of Examples 7 to 9, wherein the plurality of objects has multiple objects for each object type of multiple (different) object types, such that the multiple groups ascertained by the method have a particular group for each object type of the multiple object types, which group has the particular multiple objects of the same object type; wherein controlling the robot device to pick up the object of the multiple objects comprises: controlling the robot device to pick up an object (of the particular multiple objects) from a group of the multiple groups that has the most objects of the same object type.

Example 11 is a control device that is configured to carry out the method according to one of examples 7 to 10.

Example 12 is a robot device that has the control device according to Example 11.

Example 13 is a data processing unit that is configured to carry out a method according to one of examples 1 to 10.

Example 14 is a computer program comprising commands that, when executed by a processor, cause the processor to carry out the method according to one of examples 1 to 10.

Example 15 is a computer-readable medium that stores commands that, when executed by a processor, cause the processor to carry out the method according to one of examples 1 to 10.

In the figures, similar reference signs generally refer to the same parts throughout the various views. The figures are not necessarily true to scale, with emphasis instead generally being placed on the representation of the principles of the present disclosure. In the following description, various aspects are described with reference to the figures.

### BRIEF DESCRIPTION OF THE DRAWINGS

FIG. 1 shows a robot device arrangement according to various aspects.

FIG. 2 shows an exemplary container having multiple objects of the same object type.

FIG. 3 shows a flowchart of a method for detecting objects of the same object type in an image, according to various aspects.

FIG. 4 shows various aspects of the method according to various aspects.

### DETAILED DESCRIPTION OF EXAMPLE EMBODIMENTS

The following detailed description relates to the figures, which show, by way of explanation, specific details and aspects of this disclosure in which the present disclosure can be executed. Other aspects may be used, and structural, logical, and electrical changes may be carried out without departing from the scope of protection of the present disclosure. The various aspects of this disclosure are not necessarily mutually exclusive, since some aspects of this disclosure may be combined with one or more other aspects of this disclosure to form new aspects.

Various examples are described in more detail below.

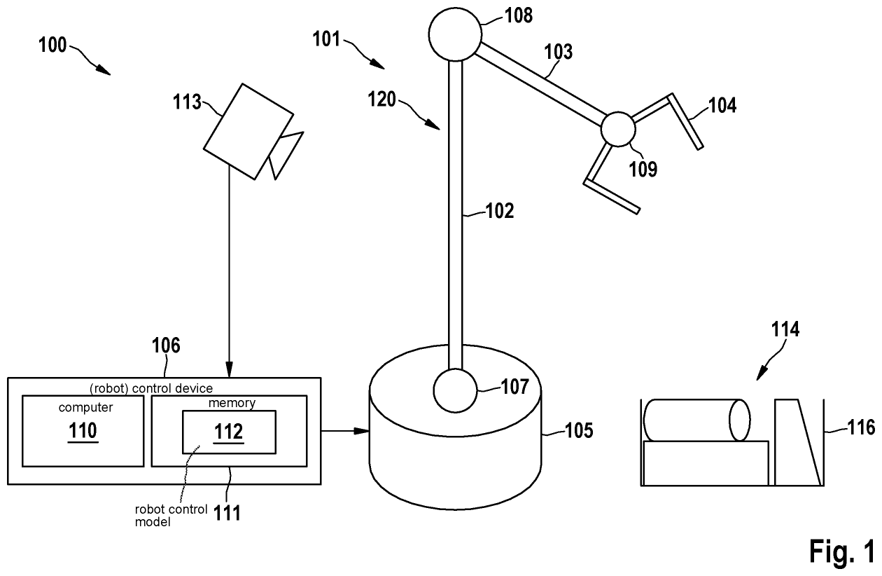

FIG. 1 shows a robot device arrangement 100 according to various aspects. The robot device arrangement 100 can comprise a robot device 101 (robot for short). The robot device 101 shown in FIG. 1 and described below by way of example is, for illustrative purposes, an exemplary robot device in the form of a robot arm 120 for picking up objects 114 from a container 116. It should be noted that the robot device is for illustrative purposes and can generally be any type of computer-controlled device, such as a robot (e.g., a manufacturing robot (e.g., for moving, assembling, or processing a workpiece), a maintenance robot, a household robot, a medical robot, etc.), a vehicle (e.g., a vehicle that is at least partially automated), a household appliance, a production machine, a personal assistant, an access control system, etc., or any other type of robot device.

The robot arm 120 can have robot links 102, 103, 104 and a base (or generally a mount) 105 by means of which the robot links 102, 103, 104 are supported. The term “robot links” can refer to the movable parts of the robot device 101, the actuation of which allows a physical interaction with the environment, for example in order to perform a task, e.g., to execute or carry out one or more skills.

In order to control the robot device 101, the robot device arrangement 100 can comprise a (robot) control device 106, which is configured to implement the interaction with the environment according to a control program. The last element 104 (as seen from the base 105) of the robot links 102, 103, 104 is also referred to as an end effector 104. The type of end effector 104 can determine whether the robot device 101 is capable of performing gripping and/or non-gripping object manipulations. A gripping object manipulation can refer to a manipulation of an object in which the object is gripped, whereas a non-gripping object manipulation can refer to a manipulation of an object in which the object is not gripped. Consequently, the robot device 101 can be capable of gripping object manipulation if the end effector 104 has at least one gripping tool (which can also be a suction device (e.g., a suction head) or the like). In any case, the robot device 101 can be capable of non-gripping object manipulation, for example by pushing the object (without gripping it), for example to change its lateral position and/or orientation.

The other robot links 102, 103 (closer to the base 105) can form a positioning device, so that, together with the end effector 104, a robot arm 120 (or articulated arm) is provided having the end effector 104 at its end. The robot arm 120 can be a mechanical arm that can provide similar functions to a human arm (possibly with a tool at its end).

The robot arm 120 can have connecting elements 107, 108, 109 which connect the robot links 102, 103, 104 to one another and to the base 105. A connecting element 107, 108, 109 can have one or more joints, each of which can provide a rotational movement and/or a translational movement (i.e., a displacement) for associated robot links relative to one another. The movement of the robot links 102, 103, 104 can be initiated by means of actuators which are controlled by the control device 106.

The term “actuator” can be understood to mean a component that is suitable for influencing a mechanism in response to being driven. The actuator can convert instructions output by the control device 106 (the so-called activation) into mechanical movements. The actuator, e.g., an electromechanical transducer, can be configured to convert electrical energy into mechanical energy in response to the triggering thereof.

The term “control device” (also referred to as “controller”) can be understood as any type of logical implementation unit that may include, for example, a circuit and/or a processor capable of executing software, firmware, or a combination thereof stored in a storage medium and that can issue the instructions, e.g., to an actuator in the present example. The control device can be configured, for example, by program code (e.g., software) to control the operation of a system, in the present example a robot.

In the present example, the control device 106 can comprise a computer 110 and a memory 111, which stores code and data on the basis of which the computer 110 controls the robot device 101.

According to various embodiments, the control device 106 can control the robot device 101 on the basis of a robot control model 112 stored in the memory 111.

As an example, the (gripping) task of the robot device 101 can be object removal, i.e., picking up (e.g., gripping or suctioning) an object of the (plurality of) objects 114 and moving the picked-up object (e.g., to a scanner, into another container, etc.). In order to be able to determine the object to be picked up and a suitable gripping position on the object, the control device 106 can use images of the working region of the robot device 101, in which region the objects 114 are located.

As another example, the (non-gripping) task of the robot device 101 can be to push the object 114 to a different position and/or to push it such that its orientation changes. In this case, the images of the working region of the robot device 101, in which region the objects 114 are located, can be used to ascertain a suitable contact position (at which the robot device 101 is to touch (but not grip) the object).

These images of the environment of the robot device 101 can be supplied by one or more imaging sensors 113 (e.g., attached to the robot arm 120 or in some other way so that the control device 106 can control the viewing angle of the one or more imaging sensors 113).

An imaging sensor as used herein may be, for example, a camera (e.g., a standard camera, a digital camera, an infrared camera, a stereo camera, etc.), a radar sensor, a LIDAR sensor, an ultrasonic sensor, etc. Therefore, an image can be an RGB image, an RGB-D image, or a depth image (also called a D image). A depth image described herein may be any type of image that includes depth information. A depth image can clearly contain 3-dimensional information about one or more objects. For example, a depth image described herein may include a point cloud provided by a LIDAR sensor and/or a radar sensor. A depth image can, for example, be an image having depth information provided by a LIDAR sensor.

The control device 106 can be configured to control the robot arm 120 in response to an input of an image into the robot control model 112 on the basis of an output of the robot control model 112.

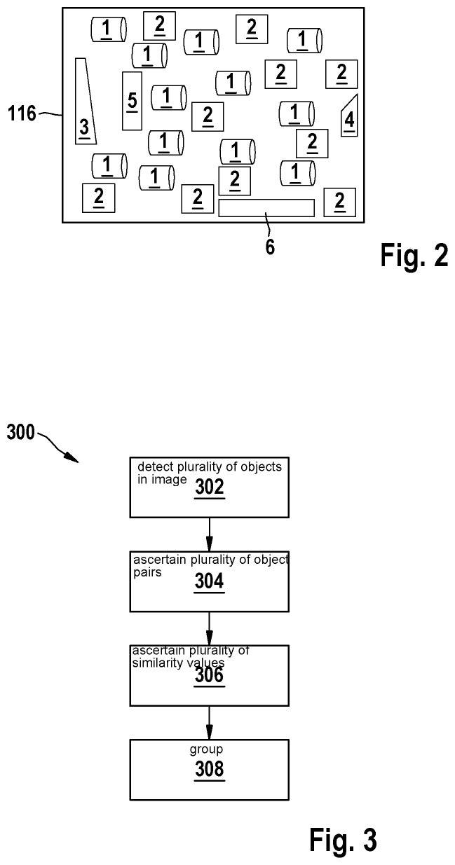

As shown in FIG. 2, it is possible that multiple objects of the same object type are present in the container 116 (which can also be referred to as a box, storage box, etc.). For illustration, FIG. 2 shows multiple first objects 1 of a first object type and multiple second objects 2 of a second object type (different from the first object type). However, the container 116 can also contain other objects that are less common (i.e., their number is lower), such as the objects 3, 4, 5, and 6. It is understood that the objects can also overlap and/or be oriented in different directions.

For various applications, it may be advantageous or even necessary to ascertain which objects are of the same object type. In one example, the container 116 can contain multiple objects for each object type of multiple object types, and the task of the robot device 101 can be to sort the objects according to their object type (e.g., to move the multiple objects of a particular object type into a corresponding other container). For example, the multiple first objects 1 shown in FIG. 2 can be sorted into a first container, and the multiple second objects 2 can be sorted into a second container (different from the first container). In another example, the objects 114 in the container 116 can be substantially homogeneous. In both cases, however, the container can also contain other, unwanted objects, such as packaging material, which are not to be removed or which are to be moved to a completely different container. However, such other objects can also be anomalies or outliers, such as a defective object. Therefore, it may be necessary in both cases to distinguish these unwanted objects from the multiple objects of the particular object type. Furthermore, knowing which objects are of the same object type can increase the probability of successfully picking up and moving the objects, as this increases the probability of ascertaining successful pickup configurations of the robot device 101 for picking up an object and/or successful trajectories for moving the object (for example, previously successful configurations and trajectories for the object type can be used).

FIG. 3 shows a flowchart of a (computer-implemented) method 300 according to various aspects.

The method 300 can comprise (in 302) detecting a plurality of objects in the image.

The method 300 can comprise (in 304) ascertaining a plurality of object pairs, which, for each object of the plurality of objects, has (exactly) one particular object pair with each other object of the plurality of objects.

The method 300 can comprise (in 306) ascertaining a plurality of similarity values by ascertaining, for each object pair of the plurality of object pairs, a particular similarity value, which represents a similarity between a first object of the object pair and a second object of the object pair according to a (predefined) similarity metric. The ascertainment of the particular similarity value can comprise: ascertaining a plurality of first feature vectors by ascertaining a particular first feature vector for multiple pixels of the image (e.g., of the particular image region) that are associated with the first object; ascertaining a plurality of second feature vectors by ascertaining a particular second feature vector for multiple pixels of the image (e.g., of the particular image region) that are associated with the second object; and ascertaining the particular similarity value using the plurality of first feature vectors and the plurality of second feature vectors.

The method 300 can comprise (in 308) grouping (e.g., clustering) the plurality of objects into multiple groups, at least one group of which contains multiple objects of the same object type, using the plurality of similarity values.

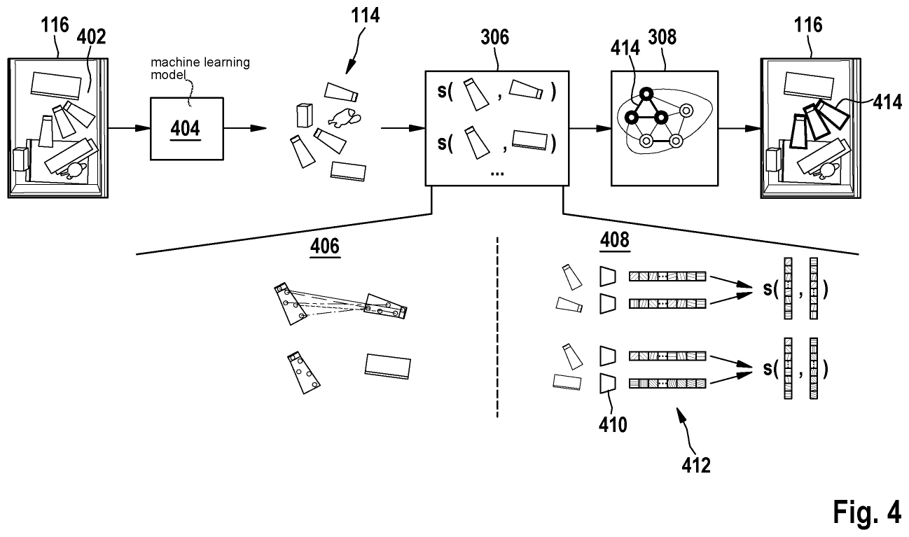

Various aspects of the method 300 are described in more detail below with reference to FIG. 4.

According to various aspects, a machine learning model 404 can be used to detect (in 302) the plurality of objects 114 in the (in this example RGB) image 402 (which shows, for example, the container 116). This machine learning model 404 can be a (e.g., open-world (e.g., segmentation)) foundation model to find objects in input data (e.g., in an image). Since the detected objects 114 are predictions of possible objects, they can also be referred to as object suggestions.

For example, the machine learning model 404 can be a text-prompt-based machine learning model that is configured to output, in response to the input of the image 402 and a text description, all objects recognized in the image 402 according to the text description as the plurality of objects 114. For example, the machine learning model 404 can be a combination of a grounding self-distillation with no labels (grounding DINO) and a segment anything model (SAM) (which is then also referred to as a grounded SAM).

It is understood that, for each detected object of the plurality of objects 114, a particular (segmentation) mask having a corresponding image region (e.g., image detail) in the image 402 is ascertained (and not just a bounding box). Each object of the plurality of objects 114 can clearly be associated with a particular image region having particular pixels.

It was found that the number of false-positively detected objects can be significantly reduced if a general generic term encompassing different object types is used as the text description. For example, a completely object-type-independent generic term such as “item,” “object,” “product,” “article,” etc. (or generic terms such as “grippable items,” etc.) can be used for this. In some applications in which only object types of a specific object category are expected, an object category (such as “screws,” “fruit,” etc.) can also be used as a generic term. Therefore, it is understood that the expression “objects of the same object type,” as used herein, refers to identical objects and not just objects of the same object category. For example, bananas and pears are objects of the same object category, fruit, but are not of the same object type (bananas #pears). In the case of screws as an object category, the object types refer to very specific screws of an explicit screw type with explicit dimensions.

In 304, the

$$( \begin{matrix}N \\ 2\end{matrix} )$$

object pairs can then be formed, where N is the number of detected objects (in 302) of the plurality of objects 114. Consequently, each object pair has a first object, ôᵢ, and a second object, ôⱼ.

In 306, for each object pair of the

$$( \begin{matrix}N \\ 2\end{matrix} )$$

object pairs, the particular similarity value can be ascertained according to the similarity metric, s (i.e., s (ôᵢ, ôⱼ)). For the plurality of objects 114, it is clearly ascertained in pairs how similar the two objects of an object pair are. According to various aspects, this particular similarity value can be ascertained using feature vectors.

In one example, the particular similarity value, s*, can be ascertained by means of a fixed-point-based approach 406 (i.e., using a fixed point similarity metric). In this case, a plurality of first fixed points, kᵢ∈Kᵢ, (also referred to as keypoints) of the first object, ôᵢ, and a plurality of second fixed points, kⱼ∈Kᵢ, of the second object, ôⱼ, can be ascertained. A fixed point estimation method can be used for this purpose, for example a traditional computer vision method such as SIFT (scale-invariant feature transform), SuperPoint (self-supervised interest point detection and description), LDD (learned detector and descriptor), DINOv2, or another fixed-point-based method.

Each first fixed point can therefore be assigned to a particular pixel of the pixels associated with the first object, and each second fixed point can be assigned to a particular pixel of the pixels associated with the second object. It is then possible to ascertain a particular first feature vector for each first fixed point and a particular second feature vector for each second fixed point. Using feature matching, fixed point pairs can then be ascertained, of which each fixed point pair has a first fixed point and an associated second fixed point. A fixed point pair can be ascertained, for example, if a fixed point pair similarity value, which represents a similarity between the first feature vector ascertained for the first fixed point and the second feature vector ascertained for the second fixed point according to another similarity metric, is greater than or equal to a fixed point pair similarity threshold. This other similarity metric can be, for example, inverse to a distance, d(f(kᵢ), f(kⱼ)), between the first feature vector, f(kᵢ), and the second feature vector, f(kⱼ).

The similarity s(ôᵢ, ôⱼ) can then be ascertained, for example, according to:

$$s ( {\hat{o}}_{i} , {\hat{o}}_{j} ) = \frac{1}{N} {\sum }_{k ∈ {K}_{i}} \text{?} [ {arg mind}_{{k}^{′} ∈ {K}_{j}} ( f ( k ) , f ( {k}^{′} ) ) < θ ] , \qquad ( 1 )$$

where [symbol] [P] is an indicator function that can be equal to one if P is true and can otherwise be zero. This allows the similarities to be categorized in a binary way as either similar or dissimilar.

Since the similarity value, s*, is not necessarily symmetrical (e.g., if the first object, ôᵢ, is or shows a subset of the second object, ôⱼ, the first fixed points, Kᵢ, have matches at the second fixed points, Kᵢ, but not the other way around), so s(ôᵢ, ôⱼ)≠s(ôⱼ, Ôᵢ), the similarity value, s*, can according to various aspects be the smaller of the two similarities, so s*=min(s(ôᵢ, ôⱼ), s(ôⱼ, ôᵢ)).

In another example, the particular similarity value, s*, can be ascertained by means of a feature averaging-based approach 408 (i.e., using a feature averaging similarity metric). It was found that this significantly increases the accuracy in recognizing objects of the same object type, in particular when it is not the same regions that are visible in the image 402.

Optionally, before the particular feature vector is ascertained, the image region of each object can be scaled to a predefined (identical, uniform) image detail size (Sₚ×Sₚ) (and filled).

Then, for each pixel

$${m}_{i}^{x , y}$$

(with x and y as pixel positions) that is associated with the (image region of the) first object, ôᵢ, a particular first feature vector,

$${f}_{i}^{x , y} ,$$

can be ascertained.

For this plurality of first feature vectors, a first mean feature vector,

$${F}_{i}^{E} ,$$

can then pe ascertained as the mean value of the first feature vectors of the first object, ôᵢ, for example according to:

$${F}_{i}^{E} = \frac{{\sum }_{x = 1}^{{S}_{p}} {\sum }_{y = 1}^{{S}_{p}} {f}_{i}^{x , y} \cdot {m}_{i}^{x , y}}{{\sum }_{x = 1}^{{S}_{p}} {\sum }_{y = 1}^{{S}_{p}} {m}_{i}^{x , y}}$$

Accordingly, for each pixel (x, y) that is associated with the (image region of the) second object, ôⱼ, a particular second feature vector,

$${f}_{j}^{x , y} ,$$

can be ascertained, and, for the plurality of second feature vectors ascertained in this way, a corresponding second mean feature vector,

$${F}_{j}^{E} ,$$

can be ascertained.

A mean feature vector 412 can also be called an object-level feature vector or a footprint. A feature vector, as described herein, can be ascertained, for example, using an encoder 410.

The particular similarity value, s*, can then be ascertained such that it represents a similarity between the first mean feature vector,

$${F}_{i}^{E} ,$$

and the second mean feature vector. For example, the similarity value, s*, can be ascertained according to:

$${s}^{*} = s ( {\hat{o}}_{i} , {\hat{o}}_{j} ) = exp ( - {‖ {F}_{i}^{E} - {F}_{j}^{E} ‖}_{2}^{2} / τ )$$

where τ indicates the temperature and can be approximately 0.07, for example.

To illustrate this, the ascertained similarity values can be represented in an N×N similarity matrix (also called an affinity matrix).

Based on the ascertained plurality of similarity values, the plurality of objects 114 can then be grouped (in 308) into the multiple groups. According to various aspects, this can be done using a graph-based clustering method (e.g., also known as a graph decomposition method). A graph-based clustering methods allows the grouping (e.g., clustering) of the plurality of objects without requiring a previously trained model (i.e., zero-shot).

In one example, the graph-based clustering method can be a minimum-cost-multicut approach. Here, each object of the plurality of objects 114 can form a particular node, V, of the graph G=(V, E), and each node can be connected to any other node by means of a particular edge, E. Each edge is clearly assigned to an object pair (ôᵢ, Ôⱼ) and can have the particular similarity value, s*, of the object pair (ôᵢ, Ôⱼ). This is the following optimization problem having the cost function c: E→ [symbol] to solve:

$${min}_{y ∈ {\{ 0 , 1 \}}^{E}} {\sum }_{e ∈ E} {c}_{e} \cdot {y}_{e}$$

$$s . t . ∀ C ∈ cycles ( G ) ∀ e ∈ C : {y}_{e} \leq {\sum }_{{e}^{′} ∈ C \backslash \{ e \}} {y}_{e}^{′} ,$$

wherein an edge label yₑ=1 indicates that the edge e is cut. This minimum-cost multicut approach is described, for example, in M. Keuper et al.: “Efficient decomposition of image and mesh graphs by lifted multicuts,” ICCV (International Conference on Computer Vision), 2015.

However, the minimum-cost multicut approach can also be interpreted probabilistically as maximum a posteriori estimates from a Bayesian model, as described in B. Andres et al.: “Globally optimal closed-surface segmentation for connectomics,” ECCV (European Conference on Computer Vision), 2012.

According to various aspects, repeated object matching can be used. In the case of the fixed point approach, a fixed value for β can be used and the probability function is the similarity function according to equation (1). In the case of the feature vector averaging approach, the probability function can be learned from the data by adapting a logistic regression model according to

$$p ( {y}_{e} = 1 \vert {s}^{*} ) = \frac{1}{1 + {e}^{- ( {β}_{0} + {β}_{1} {s}^{*} )}} ,$$

wherein the target data are positive and negative examples from the training dataset, i.e., image pairs of identical (yₑ≙0) and different (yₑ≙1) objects. The result of this optimization is then the maximum a posteriori estimate of a group of objects that are of the same object type.

If, in contrast to the minimum-cost multicut approach, only a probability threshold is used to cut edges, this cannot ensure that clusters actually form, but there could still be individual edges between objects of different object types, as a result of which, for example, two different object types could be assigned to the same group.

As shown in FIG. 4, a group having multiple objects 414 of the same object type can be ascertained in this way.

Optionally, the method 300 can also comprise classification of the at least one group that contains the multiple objects of the same object type. This can be done, for example, as a majority decision for all objects of the group, thereby increasing the accuracy (e.g., confidence) of the ascertained class for these objects.

A method for controlling a robot (e.g., the robot device 101) can comprise capturing an image (e.g., using one or more imaging sensors described herein) showing the plurality of objects (in the environment of the robot device 101, for example in the container 116). The method for controlling the robot can comprise detecting the multiple objects of the same object type, as described herein. For example, the method for controlling the robot can comprise grouping (e.g., clustering) the plurality of objects into the multiple groups in order to ascertain objects of the same object type. The method can then comprise controlling the robot to pick up (e.g., grip) (at least) one object of the multiple objects of the same object type.

For example, anomalies (e.g., defective objects) can thus be rejected because, due to their deviation (e.g., a broken screw), they are not assigned to the group of the object type (i.e., the explicit screw configuration) with which they would be associated in a non-defective state. The method 300 clearly allows anomaly detection (e.g., for rejecting defective products).

For example, the robot can be controlled to sort multiple first objects of a first object type (e.g., into a first container) and multiple second objects of a second object type (different from the first object type) (e.g., into a second container).

For example, in the case of substantially homogeneous objects, the object to be picked up can be selected from the group that has the most objects of the same object type. These objects can thus be distinguished from unwanted objects, such as packaging material (without the need for classification).

For example, when controlling the robot, the robot control model 112 can use the information that multiple objects are of the same object type to ascertain a pickup configuration of the robot for picking up the object and/or a trajectory for moving the (picked up) object. In this way, the probability of successfully manipulating the object can be increased.

A probability described herein has an assigned probability value. If a probability is compared here with another probability or a threshold (e.g., greater than, less than, higher, lower, above, etc.), this refers to the probability value assigned to the probability.

Although the approach of FIG. 3 is used in the above explanations to control the robot arm 120, it can generally be used to ascertain a control signal for controlling any technical system in a scenario where the recognition of objects of the same object type plays a role.

1-10. (canceled)

11. A method for detecting objects of the same object type in an image, the method comprising the following steps:
detecting a plurality of objects in the image;
ascertaining a plurality of object pairs, which, for each object of the plurality of objects, includes a respective object pair with each other object of the plurality of objects;
ascertaining a plurality of similarity values by ascertaining, for each object pair of the plurality of object pairs, a respective similarity value, which represents a similarity between a first object of the object pair and a second object of the object pair according to a similarity metric, wherein, for each object pair of the plurality of object pairs, the ascertainment of the respective similarity value includes:
ascertaining a plurality of first feature vectors by ascertaining a respective first feature vector for multiple pixels of the image that are associated with the first object,
ascertaining a plurality of second feature vectors by ascertaining a respective second feature vector for multiple pixels of the image that are associated with the second object, and
ascertaining the respective similarity value using the plurality of first feature vectors and the plurality of second feature vectors; and
grouping, using the plurality of similarity values, the plurality of objects into multiple groups, at least one group of which contains multiple objects of the same object type.

12. The method according to claim 11, wherein the detection of the plurality of objects in the image includes:
inputting the image and a text description into a machine learning model which is configured to output, in response to the input of the image and the text description, all objects recognized in the image according to the text description as the plurality of objects, wherein a generic term encompassing different object types is input as the text description.

13. The method according to claim 11, wherein:
the ascertainment of the plurality of first feature vectors includes: ascertaining a plurality of first fixed points of the first object, of which each first fixed point is assigned to a respective pixel of the multiple pixels associated with the first object, so that the respective first feature vector is ascertained for each first fixed point;
wherein the ascertainment of the plurality of second feature vectors includes: ascertaining a plurality of second fixed points of the second object, of which each second fixed point is assigned to a respective pixel of the multiple pixels associated with the second object, so that the respective second feature vector is ascertained for each second fixed point;
wherein the ascertainment of the respective similarity value using the plurality of first feature vectors and the plurality of second feature vectors includes:
ascertaining one or more fixed point pairs by ascertaining a respective fixed point pair including a first fixed point of the plurality of first fixed points and an associated second fixed point of the plurality of second fixed points when a fixed point pair similarity value, which represents a similarity between the respective first feature vector ascertained for the first fixed point and the respective second feature vector ascertained for the second fixed point, is greater than or equal to a fixed point pair similarity threshold, and wherein the respective similarity value for the object pair is ascertained using a number of the one or more fixed point pairs.

14. The method according to claim 12, wherein the ascertainment of the respective similarity value for each object pair of the plurality of object pairs includes:
ascertaining a plurality of first feature vectors by ascertaining a respective first feature vector for one or more pixels of the image that are associated with the first object;
ascertaining a first mean feature vector as a mean value of the plurality of first feature vectors;
ascertaining a plurality of second feature vectors by ascertaining a respective second feature vector for each pixel of the image associated with the second object;
ascertaining a second mean feature vector as a mean value of the plurality of second feature vectors; and
ascertaining the respective similarity value for the object pair such that the respective similarity value represents a similarity between the first mean feature vector and the second mean feature vector.

15. The method according to claim 11, wherein the grouping of the plurality of objects includes:
clustering the plurality of objects into the multiple groups using a graph-based clustering method.

16. A method for controlling a robot device, the method comprising the following steps:
capturing an image showing a plurality of objects in an environment of the robot device, of which multiple objects have the same object type;
detecting the multiple objects of the same object type by performing the following:
detecting the plurality of objects in the image,
ascertaining a plurality of object pairs, which, for each object of the plurality of objects, includes a respective object pair with each other object of the plurality of objects,
ascertaining a plurality of similarity values by ascertaining, for each object pair of the plurality of object pairs, a respective similarity value, which represents a similarity between a first object of the object pair and a second object of the object pair according to a similarity metric, wherein, for each object pair of the plurality of object pairs, the ascertainment of the respective similarity value includes:
ascertaining a plurality of first feature vectors by ascertaining a respective first feature vector for multiple pixels of the image that are associated with the first object,
ascertaining a plurality of second feature vectors by ascertaining a respective second feature vector for multiple pixels of the image that are associated with the second object, and
ascertaining the respective similarity value using the plurality of first feature vectors and the plurality of second feature vectors, and
grouping, using the plurality of similarity values, the plurality of objects into multiple groups, at least one group of which contains multiple objects of the same object type; and
controlling the robot device to pick up an object of the multiple objects.

17. A control device configured to control a robot device, the control device configured to perform the following steps comprising:
capturing an image showing a plurality of objects in an environment of the robot device, of which multiple objects have the same object type;
detecting the multiple objects of the same object type by performing the following:
detecting the plurality of objects in the image,
ascertaining a plurality of object pairs, which, for each object of the plurality of objects, includes a respective object pair with each other object of the plurality of objects,
ascertaining a plurality of similarity values by ascertaining, for each object pair of the plurality of object pairs, a respective similarity value, which represents a similarity between a first object of the object pair and a second object of the object pair according to a similarity metric, wherein, for each object pair of the plurality of object pairs, the ascertainment of the respective similarity value includes:
ascertaining a plurality of first feature vectors by ascertaining a respective first feature vector for multiple pixels of the image that are associated with the first object,
ascertaining a plurality of second feature vectors by ascertaining a respective second feature vector for multiple pixels of the image that are associated with the second object, and
ascertaining the respective similarity value using the plurality of first feature vectors and the plurality of second feature vectors, and
grouping, using the plurality of similarity values, the plurality of objects into multiple groups, at least one group of which contains multiple objects of the same object type; and
controlling the robot device to pick up an object of the multiple objects.

18. A robot device, comprising
a control device configured to control the robot device, the control device configured to perform the following steps including:
capturing an image showing a plurality of objects in an environment of the robot device, of which multiple objects have the same object type;
detecting the multiple objects of the same object type by performing the following:
detecting a plurality of objects in the image,
ascertaining a plurality of object pairs, which, for each object of the plurality of objects, includes a respective object pair with each other object of the plurality of objects,
ascertaining a plurality of similarity values by ascertaining, for each object pair of the plurality of object pairs, a respective similarity value, which represents a similarity between a first object of the object pair and a second object of the object pair according to a similarity metric, wherein, for each object pair of the plurality of object pairs, the ascertainment of the respective similarity value includes:
ascertaining a plurality of first feature vectors by ascertaining a respective first feature vector for multiple pixels of the image that are associated with the first object,
ascertaining a plurality of second feature vectors by ascertaining a respective second feature vector for multiple pixels of the image that are associated with the second object, and
ascertaining the respective similarity value using the plurality of first feature vectors and the plurality of second feature vectors, and
grouping, using the plurality of similarity values, the plurality of objects into multiple groups, at least one group of which contains multiple objects of the same object type; and
controlling the robot device to pick up an object of the multiple objects.

19. A non-transitory computer-readable medium on which are stored commands for controlling a robot device, the commands, when executed by a processor, causing the processor to perform the following steps:
capturing an image showing a plurality of objects in an environment of the robot device, of which multiple objects have the same object type;
detecting the multiple objects of the same object type by performing the following:
detecting a plurality of objects in the image,
ascertaining a plurality of object pairs, which, for each object of the plurality of objects, includes a respective object pair with each other object of the plurality of objects,
ascertaining a plurality of similarity values by ascertaining, for each object pair of the plurality of object pairs, a respective similarity value, which represents a similarity between a first object of the object pair and a second object of the object pair according to a similarity metric, wherein the ascertainment of the respective similarity value includes:
ascertaining a plurality of first feature vectors by ascertaining a respective first feature vector for multiple pixels of the image that are associated with the first object,
ascertaining a plurality of second feature vectors by ascertaining a respective second feature vector for multiple pixels of the image that are associated with the second object, and
ascertaining the respective similarity value using the plurality of first feature vectors and the plurality of second feature vectors, and
grouping, using the plurality of similarity values, the plurality of objects into multiple groups, at least one group of which contains multiple objects of the same object type; and
controlling the robot device to pick up an object of the multiple objects.
